(19) United States
(12) Patent Application Publication
(10) Pub. No.: US 2025/0141073 A1
(43) Pub. Date: May 1, 2025

(54) SECONDARY BATTERY

(71) Applicant: Samsung SDI Co., Ltd., Yongin-si (KR)

(72) Inventors: Min Woo KIM, Yongin-si (KR); Hwan Jun CHOI, Yongin-si (KR); Da Seong SONG, Yongin-si (KR)

(21) Appl. No.: 18/662,483

(22) Filed: May 13, 2024

(30) Foreign Application Priority Data
Oct. 27, 2023 (KR) 10-2023-0145784

(51) Int. Cl. H01M 50/59; H01M 50/103; H01M 50/14; H01M 50/15; H01M 50/531; H01M 50/548; H01M 50/586

(52) U.S. Cl. CPC H01M 50/59; H01M 50/103; H01M 50/14; H01M 50/15; H01M 50/531; H01M 50/548; H01M 50/586

(57) ABSTRACT

A secondary battery includes an electrode assembly including first and second electrode base material tabs at opposite sides, a hexahedral case for accommodating the electrode assembly, having opened ends respectively adjacent the first and second electrode base material tabs, and including first, second, third, and fourth surfaces respectively facing long and short sides of the electrode assembly, first and second cap assemblies respectively coupled to the case at the opened ends, and respectively including first and second electrode terminals respectively electrically connected to the first and second electrode base material tabs, and first and second insulators for insulation from the electrode assembly, and a retainer between at least one of the third surface or the fourth surface and at least one of the short sides, and at least partially covering the first insulator or the second insulator.

### CROSS-REFERENCE TO RELATED APPLICATION

The present application claims priority to and the benefit of Korean Patent Application No. 10-2023-0145784, filed on Oct. 27, 2023, in the Korean Intellectual Property Office, the entire disclosure of which is incorporated herein by reference.

### BACKGROUND

### 1. Field

Aspects of embodiments relate to a secondary battery capable of reducing or minimizing movement of an electrode assembly within a case.

### 2. Description of Related Art

Recently, various attempts and improvements have been made to increase capacity or performance of secondary batteries. In a typical prismatic secondary battery for battery modules used in electric vehicles, etc., the secondary battery may have a structure in which positive and negative electrode terminals are provided at an upper portion of a rectangular parallelepiped shape. The top terminal type secondary battery may have a relatively complex internal structure for providing the positive and negative terminals at the upper portion thereof. To solve this limitation, a secondary battery, in which a negative terminal is located at one end, and in which a positive terminal is located at the other end in the longitudinal direction, has been developed. This type of secondary battery is also called a side terminal type secondary battery.

The side terminal type secondary battery may be superior in terms of energy density compared to the top terminal type. If a length becomes too long, a limitation may occur in which movement of the internal electrode assembly may increase due to external vibration.

The side terminal type secondary battery may be coupled by inserting a hook into a lower end of an insulator to attach the insulator for insulating a current collector plate. This method may have difficulties in manufacturing automated equipment, in reliability of the coupling, and in a method for checking the coupling. There may be a desire to solve the above limitations.

The above-described information disclosed in the technology that serves as the background of the present disclosure is only for improving understanding, and may include information that does not constitute the related art.

### SUMMARY

Embodiments of the present disclosure provide a secondary battery in which a retainer is interposed between an electrode assembly and a case to reduce or prevent movement of the electrode assembly inside the case.

According to one or more embodiments of the present disclosure, a secondary battery includes an electrode assembly including a first electrode base material tab and a second electrode base material tab respectively at opposite sides of the electrode assembly in a longitudinal direction of the case, a hexahedral case for accommodating the electrode assembly, having opened ends respectively adjacent the first electrode base material tab and the second electrode base material tab, and including a pair of first and second surfaces respectively facing a pair of long sides of the electrode assembly, and a pair of third and fourth surfaces respectively facing a pair of short sides of the electrode assembly, a first cap assembly coupled to the case at one of the opened ends, and including a first electrode terminal electrically connected to the first electrode base material tab, and a first insulator for insulation from the electrode assembly, a second cap assembly coupled to the case at the other of the opened ends, and including a second electrode terminal electrically connected to the second electrode base material tab, and a second insulator for insulation from the electrode assembly, and a retainer between at least one of the third surface or the fourth surface and at least one of the short sides, and at least partially covering the first insulator or the second insulator.

The first insulator and the second insulator may include an insulating material.

A planar surface area of the first insulator or the second insulator may be greater than or equal to a planar surface area of a corresponding end of the electrode assembly facing the first insulator or the second insulator.

The first insulator or the second insulator may have a rectangular shape.

Central areas of the first insulator and the second insulator may define openings.

Edge areas of the first insulator and the second insulator may define holes.

The retainer may include a base area on the at least one of the short sides, an extension area extending to a portion of the first insulator or the second insulator, and a bent area configured to connect the base area to the extension area.

The extension area may define holes.

The extension area may be configured to cover an entirety of an upper

portion of an edge area of the first insulator or the second insulator.

The extension area may be configured to cover at least a portion of an edge area of the first insulator or the second insulator.

The bent area may include a substantially right angle between the base area and the extension area.

A length of the retainer may be greater than a sum of a length of the electrode assembly and a length of the first insulator or the second insulator in the longitudinal direction of the case.

Positions of the holes of the retainer may correspond to positions of the holes of the first insulator or the second insulator.

Respective portions of the holes of the retainer may overlap portions of the holes of the first insulator or the second insulator.

The holes of the retainer may be unaligned with the holes of the first insulator or the second insulator.

A size of the holes of the retainer may be less than or equal to a size of the holes of the first insulator or the second insulator.

A number of the holes of the retainer may be less than or equal to a number of the holes of the first insulator or the second insulator.

A width of the extension area may be less than a width of the short sides in the longitudinal direction of the case.

The retainer may include an insulating material.

The secondary battery may further include another retainer between the other of the at least one of the third surface or the fourth surface and the other of the at least one of the short sides, and at least partially covering the first insulator or the second insulator.

### BRIEF DESCRIPTION OF DRAWINGS

The accompanying drawings are included to provide a further understanding of the present disclosure, and are incorporated in, and constitute a part of, this specification. The drawings illustrate embodiments of the present disclosure and, together with the description, describe aspects of the present disclosure. In the drawings:

FIG. 1 is a perspective view of a secondary battery according to embodiments;

FIG. 2 is an exploded perspective view of the secondary battery shown in FIG. 1;

FIG. 3 is an enlarged cross-sectional view of a portion of the secondary battery shown in FIG. 1; and

FIGS. 4 and 5 illustrate perspective views of a state in which a retainer of a secondary battery is attached according to various embodiments.

### DETAILED DESCRIPTION

Embodiments of the present disclosure may be embodied in many different forms and should not be construed as being limited to the embodiments set forth herein. Rather, these embodiments are provided so that this disclosure will be thorough and complete and will fully convey the scope of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, embodiments will be described in detail with reference to the accompanying drawings. Embodiments of the present disclosure will be described in detail with reference to the accompanying drawings so that those skilled in the art can easily implement the present disclosure.

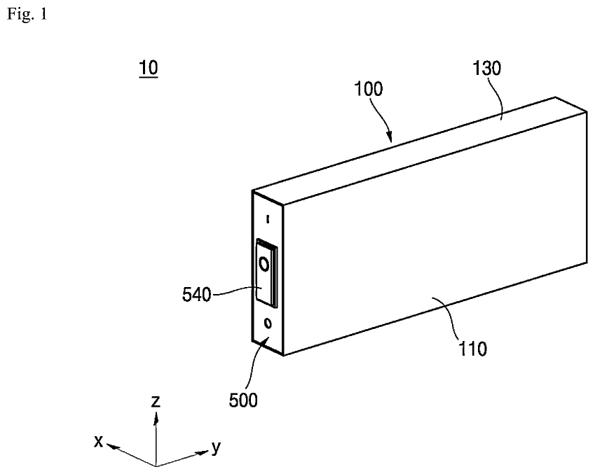

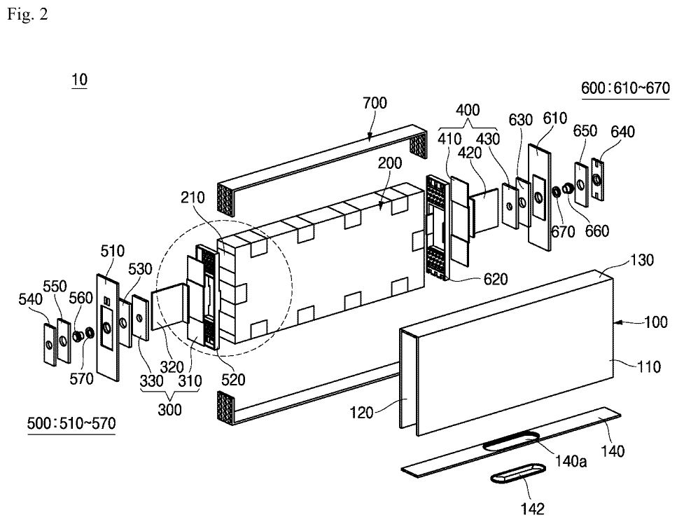

FIG. 1 is a perspective view of a secondary battery according to embodiments, and FIG. 2 is an exploded perspective view of the secondary battery shown in FIG. 1.

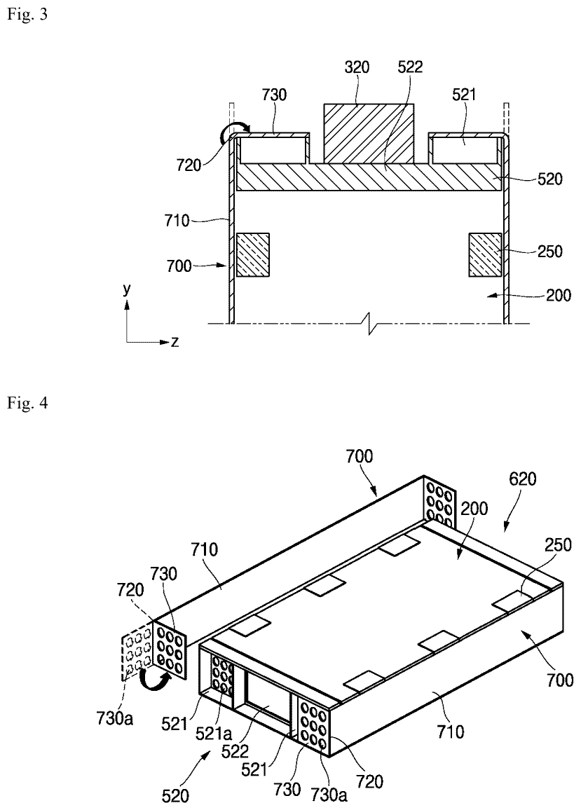

As illustrated in FIGS. 1 and 2, a secondary battery 10 according to embodiments of the present disclosure may include a case 100, may include an electrode assembly 200, a first current collector 300, and a second current collector 400, which are accommodated inside the case 100, and may include a first cap assembly 500 and a second cap assembly 600, which are coupled to the case 100. A pair of retainers 700 may be inserted between the case 100 and the electrode assembly 200 (a detailed description of the retainer will be described later with reference to FIGS. 3 to 5).

The case 100 may have a rectangular parallelepiped shape, and may have both ends that are opened in a longitudinal direction. Excluding the opened ends of the case 100, the case 100 may include a first surface 110 and a second surface 120, which are the relatively widest surfaces, and a third surface 130 and a fourth surface 140, which connect the first surface 110 to the second surface 120. A vent hole 140a to which a vent 142 is coupled may be defined in one of the third surface 130 or the fourth surface 140. In FIG. 2, the fourth surface 140, which may be a bottom surface, is illustrated as having/defining the vent hole 140a. The fourth surface 140 may be manufactured separately, and may be welded to the first surface 110 and the second surface 120. Each of the first surface 110 and the second surface 120 may have a relatively larger area than each of the third surface 130 and the fourth surface 140. In some embodiments, the first surface 110 and the second surface 120 may be defined as long sides. In some embodiments, the third surface 130 and the fourth surface 140 may be defined as short sides.

The case 100 may be made of steel, a steel alloy, aluminum, an aluminum alloy, or an equivalent thereof, but the material thereof is not limited thereto. The electrode assembly 200, the first current collector 300, and the second current collector 400 may be accommodated together with an electrolyte inside the case 100. A first cap assembly 500 and a second cap assembly 600 may be located at the opened ends of the case 100, respectively.

As illustrated in FIG. 2, the electrode assembly 200 may have a rectangular parallelepiped shape corresponding to the case 100. The electrode assembly 200 may have a shape in which there are wound or stacked a first electrode plate, a second electrode plate, and a separator interposed between the first and second electrode plates. The electrode assembly 200 may be fixed by a fixing member 250. The fixing member 250 may be made of an adhesive material, such as a tape. In some embodiments, the first electrode plate may be a positive electrode plate, and the second electrode plate may be a negative electrode plate, and vice versa.

In the first electrode plate, a positive active material layer may be located on at least one surface of aluminum (Al) foil by coating and the like. In some embodiments, the positive electrode active material layer may be transition metal oxide (LiCoO₂, LiNiO₂, LiMn₂O₄, etc.). A first electrode non-coating portion, to which the positive electrode active material layer is not located, may be provided on the first electrode plate. A plurality of first electrode base material tabs 210 may be provided by cutting the first electrode non-coating portion into a certain shape by notching or the like. The first electrode base material tab 210 may face one end of the electrode assembly 200. In some embodiments, the first electrode base material tab 210 may be divided into two portions. The first electrode base material tab 210 may be electrically connected to the first current collector 300.

In the second electrode plate, a negative electrode active material layer may be located on at least one surface of copper (Cu) or nickel foil by coating and the like. In some embodiments, the negative electrode active material layer may be made of graphite, carbon, etc. A second electrode non-coating portion, on which the negative electrode active material layer is not located, may be provided on the second electrode plate. In one or more embodiments, a plurality of second electrode base material tabs may be provided by cutting the second electrode non-coating portion into a certain shape by notching or the like. The second electrode base material tab may face the other end of the electrode assembly 200. In some embodiments, the second electrode base material tab may be divided into two portions. The second electrode base material tab may be electrically connected to the second current collector 400.

The separator may be made of polyethylene (PE) or polypropylene (PP), but the embodiments are not limited thereto. The separator may reduce or prevent the likelihood of a short circuit occurring between the first electrode plate and the second electrode plate, and may allow lithium ions to move only.

As illustrated in FIG. 2, the first current collector 300 may include a first

current collector plate 310, a first auxiliary tab 320, and a first internal terminal 330. The first current collector plate 310, the first auxiliary tab 320, and the first internal terminal 330 may be made of the same material as the first electrode base material tab 210.

The first current collector plate 310 may be provided as a thin rectangular plate, and may approximately correspond to a shape of one end of the electrode assembly 200. A size of the first current collector plate 310 may be somewhat less than that of one end of the electrode assembly 200. The first current collector plate 310 may be electrically connected to the first electrode base material tab 210 of the electrode assembly 200. Respective ends of the first current collector plate 310 may be welded to the first electrode base material tabs 210 located at the two portions. A central area of the first current collector plate 310 may protrude convexly toward the first cap assembly 500. The first auxiliary tab 320 may be welded to the convexly protruding portion of the first current collector plate 310.

The first auxiliary tab 320 may be provided as a thin rectangular plate, and one end thereof may be folded and welded to one side of the convex portion of the first current collector plate 310. The other end of the first auxiliary tab 320 may be welded to the first internal terminal 330. The first auxiliary tab 320 may be bent if the first cap assembly 500 is coupled to the case 100.

The first internal terminal 330 may be provided as a rectangular plate, and may approximately correspond in size and shape to the convex portion of the first current collector plate 310. In some embodiments, the first internal terminal 330 may have substantially the same size and shape as each of the first external terminal 540 and the first internal insulator 530, which will be described later. A circular hole may be defined by, or may pass through, a center of the first internal terminal 330. The first internal terminal 330 may be thicker than the first auxiliary tab 320.

As described above, because the first electrode base material tab 210, the first current collector plate 310, and the first internal terminal 330 are all made of the same material and welded together, the first electrode base material tab 210, the first current collector plate 310, and the first internal terminal 330 may be electrically connected to each other. A structure of the first current collector 300 described above may be equally applied to the second current collector 400. A detailed description of the second current collector 400 will be omitted (“first” is added to the names of components of the first current collector to distinguish them from the components of the second current collector).

The first cap assembly 500 may include a first cap plate 510 coupled to the case 100, a first insulator 520 for insulation from the electrode assembly 200, a first internal insulator 530 for insulation from the first current collector 300, a first external terminal 540 for electrical connection to the outside, a first external insulator 550 for insulation from the first external terminal 540, a first terminal pin 560, and a first gasket 570.

The first cap plate 510 may be provided as a rectangular plate, and a recessed groove having a rectangular shape may be defined in a center of a plate surface facing the outside, and may be defined in a center of a plate surface facing the inside. A hole for inserting the first terminal pin 560 may be defined to pass through the center of the groove.

In some embodiments, the first insulator 520 may be located between the first cap plate 510 and one end of the electrode assembly 200.

The first insulator 520 may be made of an insulating material, and may be provided in a substantially rectangular shape. A rectangular opening may be defined in a central area 522 (see FIG. 3) of the first insulator 520. In some embodiments, a non-opened edge area 521 (see FIG. 3) may be located between the first cap plate 510 and both ends of the first current collector plate 310 to insulate the first current collector plate 310 from the first cap plate 510. The first auxiliary tab 320 welded to the convex portion of the first current collector plate 310 may be exposed toward the first cap plate 510 through the opening of the first insulator 520. A plurality of holes 521a may be defined in the edge area 521 of the first insulator 520. In some embodiments, the electrolyte may be injected into the plurality of holes 521a of the edge area 521 of the first insulator 520. A planar area of the first insulator 520 may be greater than or equal to that of each of one end and the other end of the electrode assembly 200. In some embodiments, the first insulator 520 may also serve to reduce or prevent movement of the electrode assembly 200.

The first internal insulator 530 may be located between the first internal terminal 330 and the first cap plate 510. The first internal insulator 530 may be provided as a rectangular insulating material, and may be the same size or larger than the first internal terminal 330. The first internal insulator 530 may be seated in an inner rectangular groove of the first cap plate 510. A hole may be defined to pass through a center of the first internal insulator 530.

The first external terminal 540 may have a rectangular plate shape, and a hole may be defined to pass through a center of the first external terminal 540. The first external terminal 540 may be physically coupled to the first terminal pin 560 so as to be electrically connected thereto. The first external insulator 550 may be inserted between the first external terminal 540 and the first cap plate 510.

The first external insulator 550 may be made of a rectangular insulating material to insulate the first external terminal 540 from the first cap plate 510. The first external insulator 550 may be seated in an outer rectangular groove of the first cap plate 510. A hole may be defined to pass through a center of the first external insulator 550.

The first terminal pin 560 may serve to electrically connect the first external terminal 540 to the first internal terminal 330. In some embodiments, the first terminal pin 560 may be inserted to sequentially pass through the first external terminal 540, the first external insulator 550, the first cap plate 510, the first internal insulator 530, and the first internal terminal 330. An outer end of the first terminal pin 560 may be coupled to the first external terminal 540, and an inner end of the first terminal pin 560 may be coupled to the first internal terminal 330. Because the first internal terminal 330 is electrically connected to the first electrode base material tab 210, the first external terminal 540 may be a positive electrode terminal.

The first gasket 570 may be interposed between the first cap plate 510 and the first terminal pin 560, and may insulate the first cap plate 510 from the first terminal pin 560.

The above-described first cap assembly 500 may have the same structure as the second cap assembly 600, and a detailed description of the second cap assembly 600 will be omitted. The term “first” may be added to the names of the components of the first cap assembly 500 to distinguish them from the components of the second cap assembly 600. In some embodiments, the second external terminal 640 of the second cap assembly 600 may be a negative electrode terminal. If the positions of the positive electrode and the negative electrode are reversed, the first external terminal may be the negative electrode, and the second external terminal may be the positive electrode.

The electrode assembly 200 having the above-described structure may be connected to the first current collector 300 and the second current collector 400, and then may be inserted into the case 100. In some embodiments, the retainer 700 may be inserted between each of the third and fourth surfaces 130 and 140 of the case 100 and the electrode assembly 200. Hereinafter, the retainer 700 will be described in detail.

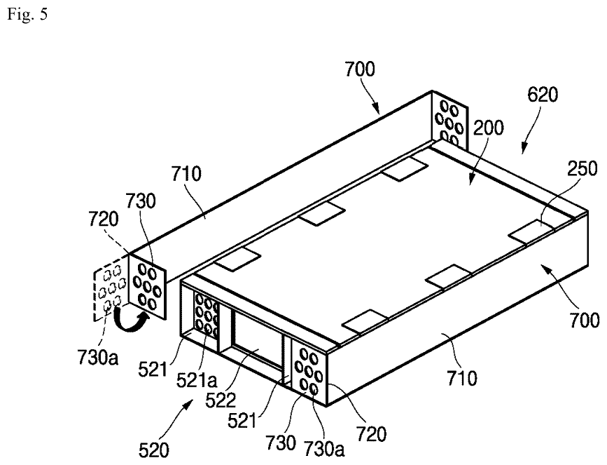

FIG. 3 is an enlarged cross-sectional view of a portion of the secondary battery shown in FIG. 1, and FIGS. 4 and 5 illustrate perspective views of a state in which a retainer of a secondary battery is attached according to various embodiments.

In some embodiments, a pair of retainers 700 may be respectively located on the third and fourth surfaces 130 and 140 of the case 100 and may be respectively located on both sides of a short side of the electrode assembly 200. In some embodiments, the retainer 700 may have both ends that are bent to respectively cover portions of a first insulator 520 and a second insulator 620.

As illustrated in FIGS. 3 and 4, the retainer 700 may have a base area 710 located on at least one of the short sides of the electrode assembly 200, and an extension area(s) 730 extending from each of both ends of the base area 710 so as to be located on an upper portion of an edge area 521 of each of the first insulator 520 and the second insulator 620. In some embodiments, the retainer 700 may have a bent area(s) 720 connecting the base area 710 to the extension area(s) 730. In some embodiments, the base area 710 may have the same length as the electrode assembly 200 in a longitudinal direction (y-axis in FIG. 3). The length of the extension area 730 may be the same at both ends, but may have lengths that are different from each other in one or more embodiments. A width of the retainer 700 (e.g., a width of the extension area 730) may be less than that of the short side of the electrode assembly 200 in the longitudinal direction of the case 100.

The retainer 700 may be made of an insulating material. In some embodiments, the retainer 700 may have an uneven shape or a wave type shape to absorb external force. The retainers 700 may be provided in a pair, and may be provided to be identical to each other. The present disclosure is not limited thereto, and the retainer 700 may have different lengths and widths.

The extension area 730 of the retainer 700 may be provided to cover an entire upper portion of the edge area 521 of each of the first insulator 520 and the second insulator 620. The entire edge area 521 excluding openings of the first insulator 520 and the second insulator 620 may be covered. The present disclosure is not limited thereto, and the extension area 730 of the retainer 700 may be provided to cover at least a portion of the edge area 521 of each of the first insulator 520 and the second insulator 620. As the extension area 730 of the retainer 700 may be provided to cover at least a portion of each of the first insulator 520 and the second insulator 620, the length of the retainer 700 (including the base area 710 and the extension area 730) may be greater than the sum of the length of the electrode assembly 200 and the height of each of the first and second insulators 520 and 620 in the longitudinal direction of the case 100.

The bent area 720 of the retainer 700 may be bent at a right angle from the base area 710 so that the extension area 730 of the above-described retainer 700 covers the first insulator 520 and the second insulator 620.

In some embodiments, referring to FIGS. 4 and 5, a plurality of holes 730a may be defined in the extension area 730 of the retainer 700. In some embodiments, the position of the hole 730a of the retainer 700 may correspond to the position of the hole 521a of each of the first insulator 520 and the second insulator 620, referring to FIG. 4. In some embodiments, the position of the holes 730a of the retainer 700 and the positions of the holes 521a of the first insulator 520 and the second insulator 620 may be identical by matching each other in a straight line. The present disclosure is not limited thereto, and at least a portion of the hole 730a of the retainer 700 may be defined to overlap the hole 521a of each of the first insulator 520 and the second insulator 620. In some embodiments, the position of the hole 730a of the retainer 700 may be defined to miss, or to not be aligned with, or to be unaligned with, the position of the hole 521a of each of the first insulator 520 and the second insulator 620.

In some embodiments, referring to FIG. 5, the position or alignment of the hole 730a of the retainer 700 and the position of the hole 521a of the first insulator 520 and the second insulator 620 may be different from each other. In some embodiments, the number of holes 730a of the retainer 700 may be different from the number of holes 521a of the first insulator 520 and the second insulator 620. For example, the number of holes 730a of the retainer 700 may be less than or equal to the number of holes 521a of the first insulator 520 and the second insulator 620.

In some embodiments, FIGS. 4 and 5 illustrate that a size of the hole 730a of the retainer 700 is the same as that of the hole 521a of each of the first insulator 520 and the second insulator 620, but the size of the hole 730a of the retainer 700 may be less than that of the hole 521a of each of the first insulator 520 and the second insulator 620.

In some embodiments, both ends of the retainer 700 may be bent to surround and fix the first and second insulators 520 and 620, thereby eliminating a process of fixing the insulator through hook coupling so as to improve process efficiency. In some embodiments, the retainer 700 may be attached to top surfaces of the first and second insulators 520 and 620, in which the holes 521a are defined, to block welding foreign substances that may be generated during a welding process, and the hole 730a may be defined in the portion of the retainer 700 attached to the top surface of each of the insulators 520 and 620 to allow a liquid to be injected.

According to the embodiments of the present disclosure, both of the ends of the retainer may be bent to surround and fix the insulator, thereby eliminating the process of fixing the insulator through the hook so as to improve the process efficiency.

According to the embodiments of the present disclosure, the retainer may be attached to the top surface of the insulator, in which the punched hole is defined, to block the foreign welding substances generated during the welding process, and also, the punched hole may be defined in the portion of the retainer attached to the top surface of the insulator to inject the liquid through the punched hole.

According to embodiments of the present disclosure, the retainer may be provided at the portion to which much of the external force is applied to reduce or minimize the movement of the electrode assembly. The likelihood of a rupture of a tab, which may be caused by the movement of the electrode assembly, may be reduced or prevented to reduce or prevent damage potentially leading to internal short-circuit.

The above is merely one or more embodiments, and the present disclosure is not limited to the foregoing, and also it will be understood by those of ordinary skill in the art that various changes in form and details may be made therein without departing from the spirit and scope of the present disclosure as defined by the following claims, with functional equivalents thereof to be included therein.

What is claimed is:

1. A secondary battery comprising:
an electrode assembly comprising a first electrode base material tab and a second electrode base material tab respectively at opposite sides of the electrode assembly;
a hexahedral case for accommodating the electrode assembly, having opened ends respectively adjacent the first electrode base material tab and the second electrode base material tab, and comprising a pair of first and second surfaces respectively facing a pair of long sides of the electrode assembly, and a pair of third and fourth surfaces respectively facing a pair of short sides of the electrode assembly;
a first cap assembly coupled to the case at one of the opened ends, and comprising a first electrode terminal electrically connected to the first electrode base material tab, and a first insulator for insulation from the electrode assembly;
a second cap assembly coupled to the case at the other of the opened ends, and comprising a second electrode terminal electrically connected to the second electrode base material tab, and a second insulator for insulation from the electrode assembly; and
a retainer between at least one of the third surface or the fourth surface and at least one of the short sides, and at least partially covering the first insulator or the second insulator.

2. The secondary battery as claimed in claim 1, wherein the first insulator and the second insulator comprise an insulating material.

3. The secondary battery as claimed in claim 1, wherein a planar surface area of the first insulator or the second insulator is greater than or equal to a planar surface area of a corresponding end of the electrode assembly facing the first insulator or the second insulator.

4. The secondary battery as claimed in claim 1, wherein the first insulator or the second insulator has a rectangular shape.

5. The secondary battery as claimed in claim 1, wherein central areas of the first insulator and the second insulator define openings.

6. The secondary battery as claimed in claim 1, wherein edge areas of the first insulator and the second insulator define holes.

7. The secondary battery as claimed in claim 6, wherein the retainer comprises:
a base area on the at least one of the short sides;
an extension area extending to a portion of the first insulator or the second insulator; and
a bent area configured to connect the base area to the extension area.

8. The secondary battery as claimed in claim 7, wherein the extension area defines holes.

9. The secondary battery as claimed in claim 8, wherein the extension area is configured to cover an entirety of an upper portion of an edge area of the first insulator or the second insulator.

10. The secondary battery as claimed in claim 8, wherein the extension area is configured to cover at least a portion of an edge area of the first insulator or the second insulator.

11. The secondary battery as claimed in claim 8, wherein the bent area comprises a substantially right angle between the base area and the extension area.

12. The secondary battery as claimed in claim 8, wherein a length of the retainer is greater than a sum of a length of the electrode assembly and a length of the first insulator or the second insulator in a longitudinal direction of the case.

13. The secondary battery as claimed in claim 8, wherein positions of the holes of the retainer correspond to positions of the holes of the first insulator or the second insulator.

14. The secondary battery as claimed in claim 8, wherein respective portions of the holes of the retainer overlap portions of the holes of the first insulator or the second insulator.

15. The secondary battery as claimed in claim 8, wherein the holes of the retainer are unaligned with the holes of the first insulator or the second insulator.

16. The secondary battery as claimed in claim 8, wherein a size of the holes of the retainer is less than or equal to a size of the holes of the first insulator or the second insulator.

17. The secondary battery as claimed in claim 8, wherein a number of the holes of the retainer is less than or equal to a number of the holes of the first insulator or the second insulator.

18. The secondary battery as claimed in claim 7, wherein a width of the extension area is less than a width of the short sides in a longitudinal direction of the case.

19. The secondary battery as claimed in claim 1, wherein the retainer comprises an insulating material.

20. The secondary battery as claimed in claim 1, further comprising another retainer between the other of the at least one of the third surface or the fourth surface and the other of the at least one of the short sides, and at least partially covering the first insulator or the second insulator.
